(19) United States
(12) Patent Application Publication
(10) Pub. No.: US 2013/0041828 A1
(43) Pub. Date: Feb. 14, 2013

(54) Systems, Methods, and Apparatus for Managing Digital Content and Rights Tokens

(71) Applicants: Francisco Gonzalez, Atlanta, GA (US); Yousef Wasef Nijim, Roswell, GA (US)

(72) Inventors: Francisco Gonzalez, Atlanta, GA (US); Yousef Wasef Nijim, Roswell, GA (US)

(73) Assignee: COX COMMUNICATIONS, INC., Atlanta, GA (US)

(21) Appl. No.: 13/207,139

(22) Filed: Aug. 10, 2011

(51) Int. Cl. G06F 21/22

(52) U.S. Cl. 705/51

(57) ABSTRACT

Certain embodiments of the invention may include systems, methods, and apparatus for managing digital content and rights tokens. According to an example embodiment of the invention, a method is provide for managing digital content from one or more sources for multimedia on demand (MOD). The method can include receiving a rights token associated with the digital content; retrieving the digital content based at least in part on the received rights token; translating the digital content for MOD delivery when the digital content is not available in a MOD format; and preparing a unified listing of available content comprising the digital content, from one or more of internal sources, content ecosystems, or third parties.

### FIELD OF THE INVENTION

This invention generally relates to digital content, and more particularly, to management of digital content and rights tokens.

### BACKGROUND OF THE INVENTION

Digital content or media can include video on demand, downloadable movies, music, games, electronic books, audio books, etc. This content can be delivered for use directly to a consumer's device via the internet, cellular network, RF, and/or other connections. The infrastructure for managing digital media tends to evolve as new techniques are developed for handling access to the media. For example, with the aid of certain standards bodies and consortia, there now exist cooperative infrastructure designs that allow consumers to purchase rights to the digital content from any of a number of retailers, and to access their purchased content from any number of devices in any number of locations.

The Digital Entertainment Content Ecosystem (DECE) is an industry association that has developed a system to allow customers to purchase movies and play them on any device. The DECE consists of retailers, content publishers, CE manufacturers, digital service providers, etc., and it is connected to a global management entity called the Coordinator which provides account management, device and domain management and rights locker services to all the participants. Other ecosystems include Disney's KeyChest and Apple's iTunes. These ecosystems expand the traditional model of content sales (for example, purchasing and downloading media from the same entity) to make it easier for consumers to purchase content from any participating retailer, and to access or download the content from any suitable service provider or network operator. Nevertheless, challenges and opportunities still exist within the cooperative infrastructure to integrate with third party service provider ecosystems, manage the digital content, handle rights tokens, and/or provide a better experience for the consumer.

### BRIEF SUMMARY OF THE INVENTION

Some or all of the above needs may be addressed by certain embodiments of the invention. Certain embodiments of the invention may include systems, methods, and apparatus for managing digital content and rights tokens.

According to an example embodiment of the invention, a method is provided for managing digital content from one or more sources for multimedia on demand (MOD). The method can include receiving a rights token associated with the digital content; retrieving the digital content based at least in part on the received rights token; translating the digital content for MOD delivery when the digital content is not available in a MOD format; and preparing a unified listing of available content comprising the digital content, from one or more of internal sources, content ecosystems, or third parties.

According to another example embodiment, a system is provided for integrating, aggregating, and providing digital content from one or more sources for multimedia on demand (MOD). The system can include one or more networks; at least one memory for storing data and computer-executable instructions; at least one processor in communication with the one or more networks, wherein the at least one processor is configured to access the at least one memory. The at least one processor is further configured to execute the computer-executable instructions for interpreting a rights token associated with the digital content; processing the digital content, based at least in part on the received rights token; translating the digital content for multimedia on demand (MOD) delivery when the digital content is not available in a MOD format; and preparing a unified listing of available content comprising the digital content, from one or more of internal sources, content ecosystems, or third parties.

According to another example embodiment, an apparatus is provided for integrating, aggregating, and providing digital content from one or more sources for multimedia on demand (MOD). The apparatus includes at least one memory for storing data and computer-executable instructions; at least one processor configured to access the at least one memory. The at least one processor is further configured to execute the computer-executable instructions for interpreting a rights token associated with the digital content; processing the digital content, based at least in part on the received rights token; translating the digital content for multimedia on demand (MOD) delivery when the digital content is not available in a MOD format; and preparing a unified listing of available content, wherein the available content comprises the digital content.

Other embodiments and aspects of the invention are described in detail herein and are considered a part of the claimed invention. Other embodiments and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a block diagram of an illustrative digital content ecosystem, according to an example embodiment of the invention.

FIG. 2 is a block diagram of an illustrative rights locker aggregation system, according to an example embodiment of the invention.

FIG. 3 is a block diagram of an illustrative digital content system, according to an example embodiment of the invention.

FIG. 4 is a flow diagram of an example method according to an example embodiment of the invention.

FIG. 5 is a flow diagram of another example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain embodiments of the invention may enable access of information contained in external content ecosystems, and may further allow integration into third party service provider content ecosystems. According to certain example embodiments, a third party service provider may enhance its products and services with content purchased by consumers from retail outlets or other points of sale external to the service provider.

According to example embodiments of the invention, various systems, methods and apparatus enable a particular provider to integrate its subscribers' external purchases (i.e., purchased from different retailers and captured in different content ecosystems) with purchases made locally within the particular provider's own ecosystem. For example, an on-demand service handled by the particular provider may present the subscriber with a unified listing of the user's available assets (for example, movie titles) even if some of the assets were purchased from a third party retailer. Example embodiments of the invention integrate new business models enabled by The DECE (Digital Content Entertainment Ecosystem) and other content ecosystems with an on-demand service to provide the subscriber with an enhanced viewing experience by seamlessly aggregating all their purchased content in one easy to use application. Example embodiments of the invention will now be described with reference to the accompanying figures and flow-diagrams.

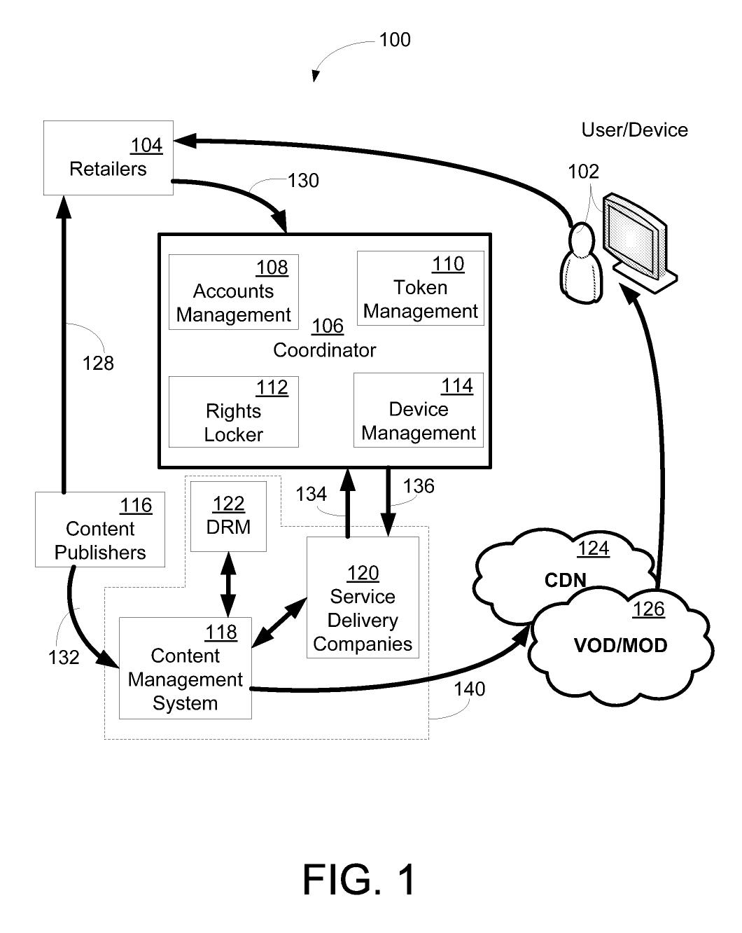

FIG. 1 illustrates an example digital content ecosystem 100, which, according to an example embodiment of the invention, may include purchasing, rights management, and service delivery. Such an ecosystem 100 may be utilized for aspects involved in purchasing, managing, and/or delivering digital content. According to example embodiments of the invention, digital content can include, but is not limited to multimedia-on-demand (MOD), video-on-demand (VOD), downloadable movies, music, games, electronic books, audio books, software, etc. In an example embodiment, a user 102 may purchase rights to the digital content from a retailer 104. According to certain example embodiments of the invention, the retailer 104 may be any one of a number of different retailers that are participating in the content ecosystem 100. In an example embodiment, when digital content is purchased from the retailer 104, a transaction information 130 indicating a purchase may be sent to the Coordinator 106 to generate a rights token, and to carry out the process of accounts management 108, rights token management 110 (which may involve a rights locker 112), and device management 114. In an example embodiment, purchase information associated with a particular user 102 may be communicated to the rights locker 112, and access rights information for the user 102 may be handled by the accounts management system 108 associated with the Coordinator 106. In an example embodiment, the received access rights information may be stored. In an example embodiment, once access rights information has been determined and/or assembled for any user 102 associated with a particular account, the accounts management system 108 may analyze the access rights information in order to determine whether to allow access to the desired content. In certain embodiments, a determination may be made as to whether multiple users that are associated with an account are authorized to access the desired content. If it is determined that one or more of the identified users are authorized to access the content, then the device management system 114 may further be used to determine if the user's device is appropriate and/or authorized to access the requested content. In certain example embodiments, the device management system 114 may also be utilized to provide information to the service delivery company 120 for how the content should be formatted for delivery and/or use on a particular device.

In an example embodiment, the coordinator 106 may communicate a rights token 136 with the service delivery company 120. The service delivery company 120 may communicate with a content management system 118, which may be in communication with a digital rights management system 122. In an alternative example embodiment, the service deliver company 120 may include the content management system 118 and the digital rights management system 122 (as indicated by the dashed line 140). Content publishers 116 may provide assets 132 to the content management system 118, and the assets 132 may include metadata, and may be encrypted according to a standard content publishing specification. In an example embodiment, the content publisher 116 may also be in communication with the retailer 104, for example, to provide a listing 128 of content available for purchase.

According to an example embodiment of the invention, the content management system 118 may provide the content to the user 102 via a content delivery network (CDN) 124 or by a multimedia-on-demand (or video-on-demand) (VOD/MOD) network 126. According to an example embodiment, once the content has been delivered, an indication 134 may be sent to the Coordinator 106 that the rights token has been consumed.

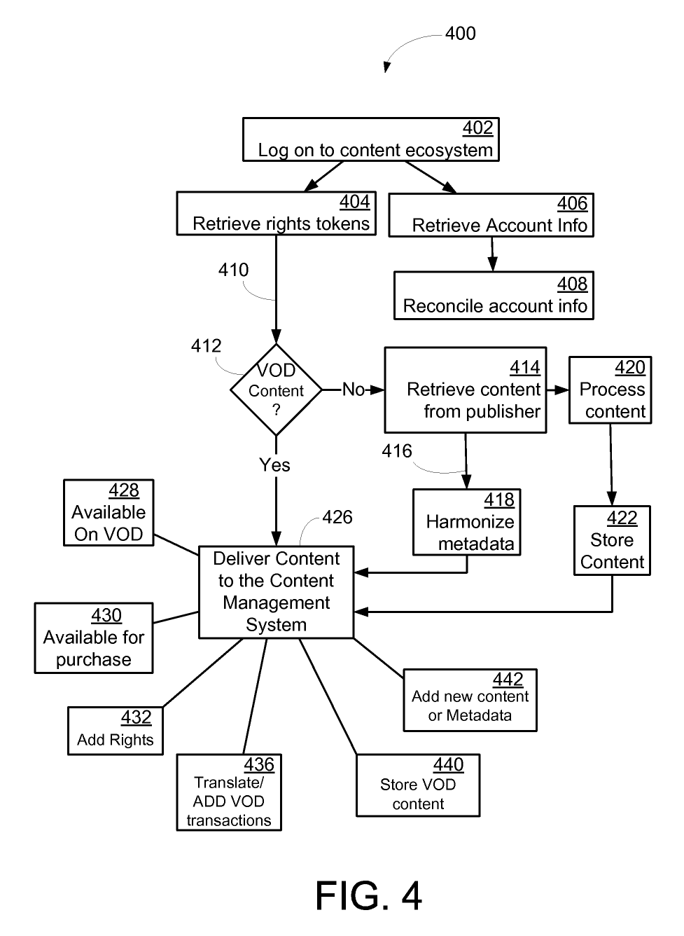

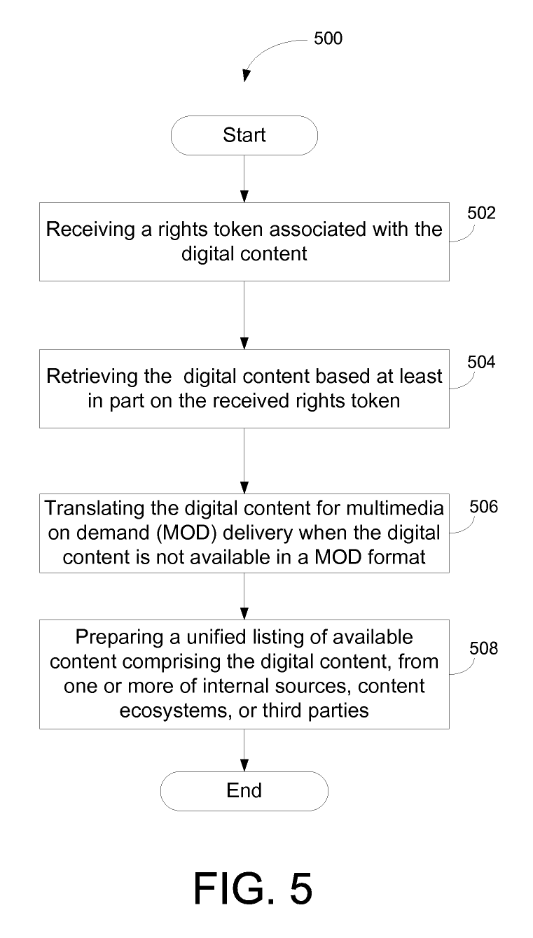

According to an example aspect of the invention, a service delivery company 120 may receive digital content 132 from a content publisher 116 via the content management system 118. Depending on the form of delivery (e.g., encryption, etc.) by the content publisher 116, the service delivery company 120 may convert the digital content 132 for appropriate delivery to the user 102 via the CDN network 124 or the VOD/MOD network 126. Further details regarding this type of action will be revisited below in the descriptions of FIGS. 4 and 5.

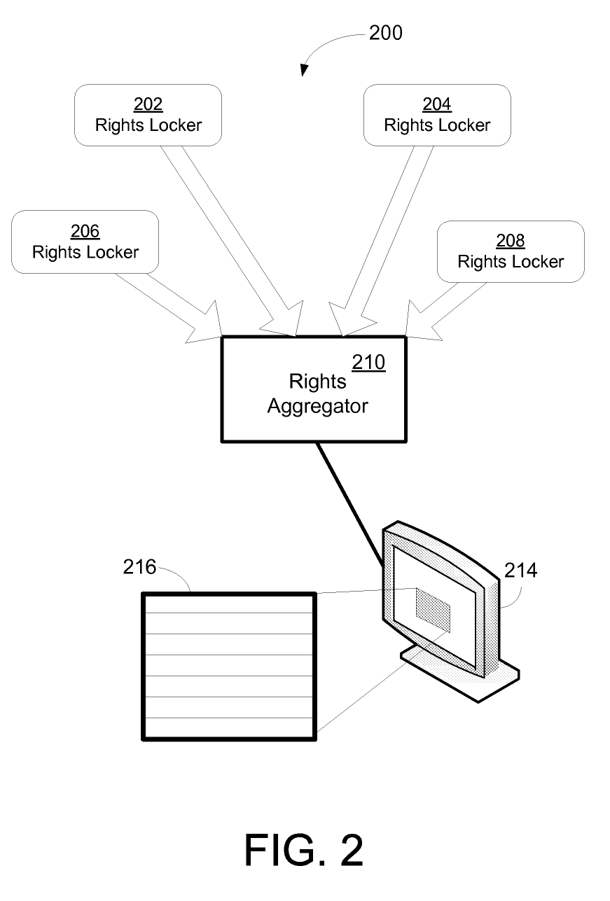

FIG. 2 depicts a rights locker aggregation system 200, according to an example embodiment of the invention. Example embodiments of the right locker system 200 may include various rights lockers 202-208, which may store rights information that may pertain to content controlled, owned, or provided by different entities or content publishers. For example, rights related to digital content controlled by Company A may be stored in a first right locker 202; rights related to digital content controlled by Company B may be stored in a second right locker 204; rights related to digital content controlled by Company C may be stored in a third rights locker 206, and so forth.

In an example embodiment of the invention, a rights aggregator 210 may be utilized to access the rights information from the rights lockers 202-208 for a particular user, and the rights aggregator 210 may combine the rights information in a unified menu listing 216 for display on the user interface 214. In an example embodiment, the rights aggregator 210 may be part of the Coordinator (as in 106 of FIG. 1). According to an example embodiment, the unified menu listing 216 may list content that is available to the particular user, based on login credential information provided by the user. For example, an on-demand service handled by a particular provider may present the subscriber with a unified listing of the user's available assets (for example movie titles) even if some of the assets were purchased from a third party retailer.

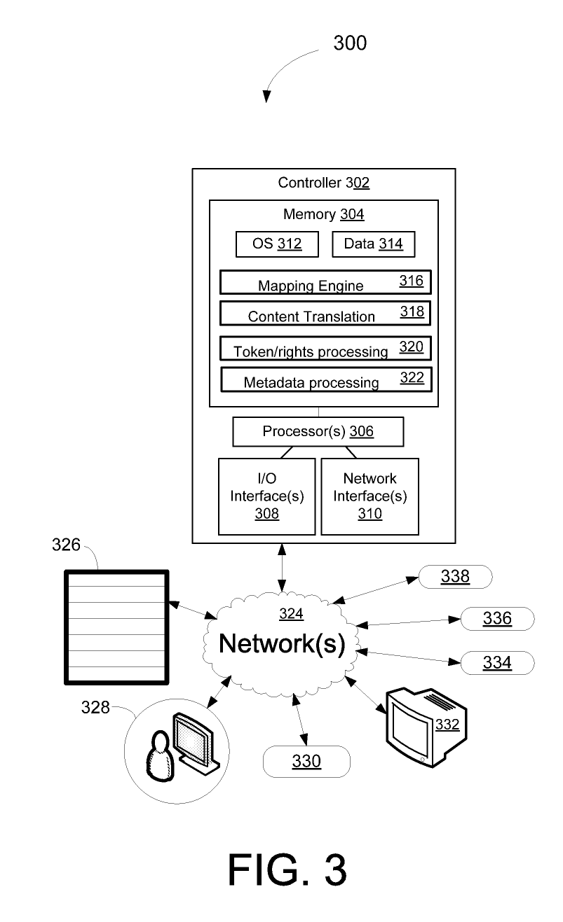

FIG. 3 depicts a block diagram of an illustrative digital content system 300, according to an example embodiment of the invention. Embodiments of the digital content system 300 may be included in the content management system (as in 118 of FIG. 1) and/or may reside with the service delivery companies (as in 120 of FIG. 1). According to an example embodiment, the system 300 may include a controller 302, which may include a memory 304. In example embodiments, the memory 304 may include an operating system 312 and data 314. According to example embodiments, the memory 304 may further include one or more of the following modules: mapping engine 316, content translation 318, token/rights processing 320, and metadata processing 322. In an example embodiment, the controller 302 may include one or more processors 306, one or more input/output interface(s) 308, and/or one or more network interface(s) 322. The one or more network interface(s) 322 may be in communication with one or more networks 324. The one or more networks 324, for example, may provide communications channels for content listings 326, providing content to a user device 328, reporting transaction information to affiliated third party ecosystems 330, and/or providing data for use with local or remote workstations 332 (for example, system administrator terminals). The one or more networks 324 may further provide a communications channel for interaction with third party content ecosystems 334, internal content ecosystems 336, and/or external party systems 334.

FIG. 4 illustrates an example method flow diagram 400, according to an embodiment of the invention. The method 400 may allow a service delivery company to manage digital content for use with legacy video on demand systems, and to process metadata embedded in the content for use with listings, menus, advertisements, etc. In block 402, and according to an example embodiment, user credentials may be utilized to log on to a content ecosystem. In block 406, account information may be retrieved, and if necessary, the account information may be reconciled in block 408. For example, reconciling account information may include updating user information or updating listings of available content.

According to an example embodiment, and with reference to block 404, rights tokens for authorized content may be retrieved, for example via a coordinator (such as Coordinator 106, FIG. 1) and transaction information related to the authorized content may be evaluated in decision block 412 to determine if the content is in a video-on-demand (VOD) format. For example, the content may already be in a MPEG-2 format, which may work well with legacy VOD systems, and such content can be passed to a content management system (such as the content management system 118, FIG. 1) in block 426. However, content publishers may present the content in a H.264 or MPEG-4 format, and such content may need to be converted by the service delivery company (as in 120, FIG. 1) or the content management system (as in 118, FIG. 1) to MPEG-2 for use with the legacy VOD system. In block 414, and according to an example embodiment, the content may be retrieved from the publisher. In block 420, and according to an example embodiment, the content may be processed (e.g., converted), and then the processed content may be stored for use with the content management system 426, as indicated by block 422. In an example embodiment, metadata may be read from the content and may be harmonized or formatted in block 418 for delivery to the content management system, as indicated by block 426. For example, harmonizing metadata may include retrieving metadata from the H.264-encrypted content, and providing the metadata information in titles, actor lists, play times, etc.

With continued reference to FIG. 4, and according to an example embodiment of the invention, the content management system may process and/or control the content, metadata, and/or rights tokens for various additional functions. For example, once VOD content becomes available (or after it has been converted from H.264 content) such content may be displayed or advertized as being available, as indicated by block 428. In an example embodiment, the display or advertisement of the content, as indicated in block 428, may include presenting metadata in lists or images on the user device. In another example embodiment, the display or advertisement of the content may be based on user preferences, viewing history, or genre matching algorithms. According to an example embodiment, the content may be listed as available for purchase as indicated by block 430. In an example embodiment, the content management system may add rights to the internal rights locker, as indicated by block 432. In an example embodiment, the content management system may translate and add VOD transactions to a database, as indicated by block 436. In an example embodiment, the content management system may store VOD content and metadata to a database, as indicated by block 440. In an example embodiment, the content management system may add new content and/or metadata existing content and/or metadata, as indicated by block 442.

An example method 500 for managing digital content from one or more sources for multimedia on demand (MOD) will now be described with reference to the flowchart of FIG. 5. The method 500 starts in block 502 and according to an example embodiment of the invention, includes receiving a rights token associated with the digital content. In block 504, the method 500 includes retrieving the digital content based at least in part on the received rights token. In block 506, the method 500 includes translating the digital content for MOD delivery when the digital content is not available in a MOD format. In block 508, the method 500 includes preparing a unified listing of available content comprising the digital content, from one or more of internal sources, content ecosystems, or third parties. The method 500 ends after block 508.

Example embodiments of the invention can further include delivering MOD formatted digital content to an authorized device. Example embodiments of the invention can further include receiving metadata associated with the digital content. Example embodiments of the invention can further include harmonizing metadata associated with the digital content for use with the unified listing. According to an example embodiment, the digital content may be received from one or more content publishers. Example embodiments of the invention can further include reporting purchases of digital content to third party ecosystems. Example embodiments of the invention can further include reporting rights token usage to one or more coordinators.

Example embodiments of the invention can include system and/or an apparatus for integrating, aggregating, and providing digital content from one or more sources for multimedia on demand (MOD). Example embodiments of the system can include one or more networks. Example embodiment of the system and/or an apparatus can include at least one memory for storing data and computer-executable instructions; at least one processor in communication with the one or more networks, wherein the at least one processor is configured to access the at least one memory and further configured to execute the computer-executable instructions for interpreting a rights token associated with the digital content; processing the digital content, based at least in part on the received rights token; translating the digital content for multimedia on demand (MOD) delivery when the digital content is not available in a MOD format; and preparing a unified listing of available content comprising the digital content, from one or more of internal sources, content ecosystems, or third parties.

In example embodiments, the at least one processor is further configured for directing MOD formatted digital content to an authorized device. In an example embodiment, the at least one processor is further configured for receiving and harmonizing metadata associated with the digital content for display in a unified content listing. Example embodiments further include a rights processing module for managing rights to the digital content. In an example embodiment, the rights processing module is configured for reporting purchases of the digital content to one or more third party ecosystems. In an example embodiment, at least one processor is further configured for reporting rights token usage to one or more coordinators.

Accordingly, example embodiments of the invention can provide the technical effects of creating certain systems, methods, and apparatus that provide interpretation of the rights tokens. Example embodiments of the invention can provide the further technical effects of providing systems, methods, and apparatus for translating content.

In example embodiments of the invention, the digital content ecosystem 100, the rights locker system 200, and/or the digital content system 300 may include any number of hardware and/or software applications that are executed to facilitate any of the operations. In example embodiments, one or more I/O interfaces may facilitate communication between the digital content ecosystem 100, the rights locker system 200, and/or the digital content system 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the digital content ecosystem 100, the rights locker system 200, and/or the digital content system 300. The one or more I/O interfaces may be utilized to receive or collect data and/or user instructions from a wide variety of input devices. Received data may be processed by one or more computer processors as desired in various embodiments of the invention, and/or stored in one or more memory devices.

One or more network interfaces may facilitate connection of the digital content ecosystem 100, the rights locker system 200, and/or the digital content system 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a BluetoothTM (owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, embodiments of the invention may include the digital content ecosystem 100, the rights locker system 200, and/or the digital content system 300 with more or less of the components illustrated in FIGS. 1, 2 and 3.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method for managing digital content from one or more sources for multimedia on demand (MOD), the method comprising:
receiving a rights token associated with the digital content;
retrieving the digital content based at least in part on the received rights token;
translating the digital content for MOD delivery when the digital content is not available in a MOD format; and
preparing a unified listing of available content comprising the digital content, from one or more of internal sources, content ecosystems, or third parties.

2. The method of claim 1, further comprising delivering MOD formatted digital content to an authorized device.

3. The method of claim 1, further comprising receiving metadata associated with the digital content.

4. The method of claim 1, further comprising harmonizing metadata associated with the digital content for use with the unified listing.

5. The method of claim 1, wherein the digital content is received from one or more content publishers.

6. The method of claim 1, further comprising reporting purchases of digital content to third party ecosystems.

7. The method of claim 1, further comprising reporting rights token usage to one or more coordinators.

8. A system for integrating, aggregating, and providing digital content from one or more sources for multimedia on demand (MOD); the system comprising:
one or more networks;
at least one memory for storing data and computer-executable instructions;
at least one processor in communication with the one or more networks, wherein the at least one processor is configured to access the at least one memory and further configured to execute the computer-executable instructions for:
interpreting a rights token associated with the digital content;
processing the digital content, based at least in part on the received rights token;
translating the digital content for multimedia on demand (MOD) delivery when the digital content is not available in a MOD format; and
preparing a unified listing of available content comprising the digital content, from one or more of internal sources, content ecosystems, or third parties.

9. The system of claim 8, wherein the at least one processor is further configured for directing MOD formatted digital content to an authorized device.

10. The system of claim 8, wherein the at least one processor is further configured for receiving and harmonizing metadata associated with the digital content for display in a unified content listing.

11. The system of claim 8, further comprising a rights processing module for managing rights to the digital content.

12. The system of claim 11, wherein the rights processing module is configured for reporting purchases of the digital content to one or more third party ecosystems.

13. The system of claim 8, wherein the at least one processor is further configured for reporting rights token usage to one or more coordinators.

14. An apparatus for integrating, aggregating, and providing digital content from one or more sources for multimedia on demand (MOD); the apparatus comprising:
at least one memory for storing data and computer-executable instructions;
at least one processor configured to access the at least one memory and further configured to execute the computer-executable instructions for:
interpreting a rights token associated with the digital content;
processing the digital content, based at least in part on the received rights token;
translating the digital content for multimedia on demand (MOD) delivery when the digital content is not available in a MOD format; and
preparing a unified listing of available content, wherein the available content comprises the digital content.

15. The apparatus of claim 14, wherein the at least one processor is further configured for directing MOD formatted digital content to an authorized device.

16. The apparatus of claim 14, wherein the at least one processor is further configured for receiving and harmonizing metadata associated with the digital content for display in a unified content listing.

17. The apparatus of claim 14, further comprising a rights processing module for managing rights to the digital content.

18. The apparatus of claim 17, wherein the rights processing module is configured for reporting purchases of the digital content to one or more third party ecosystems.

19. The apparatus of claim 14, wherein the at least one processor is further configured for reporting rights token usage to one or more coordinators.

20. The apparatus of claim 14, wherein the at least one processor is further configured for preparing the unified listing of available content from one or more of internal sources, content ecosystems, or third parties.
